(19) United States
(12) Patent Application Publication
(10) Pub. No.: US 2021/0279677 A1
(43) Pub. Date: Sep. 9, 2021

(54) MULTI VARIETY FLEET COLD CHAIN MANAGEMENT HARDWARE MODULE SYSTEM

(71) Applicant: CARRIER CORPORATION, Palm Beach Gardens, FL (US)

(72) Inventors: Marc Beasley, Beverly, MA (US); Ciara Poolman, Syracuse, NY (US); Robert A. Chopko, Baldwinsville, NY (US); John Cronin, Bonita Springs, FL (US); Seth Melvin Cronin, Essex Junction, VT (US)

(21) Appl. No.: 16/319,586

(22) PCT Filed: Jul. 20, 2017
(86) PCT No.: PCT/US2017/043056

§ 371 Date: Jan. 22, 2019

Related U.S. Application Data
(60) Provisional application No. 62/365,743, filed on Jul. 22, 2016.

(51) Int. Cl. G06Q 10/08; B60W 50/08; B60W 50/10; B60W 50/14

(52) U.S. Cl. CPC G06Q 10/0832; B60W 50/085; B60W 2050/143; B60W 50/14; B60W 50/10

(57) ABSTRACT

A system for managing perishable goods within a cold chain distribution system including: a transport refrigeration system including: a refrigerated container; a refrigeration unit coupled to refrigerated container; a controller configured to control the operation of the refrigeration unit; and a plurality of sensors configured to monitor parameters associated with at least one of N the perishable goods, refrigeration unit, and refrigerated container, the plurality of sensors configured to transmit parameters to the controller. The system also includes: a first user device located proximate to refrigerated container and configured to allow manual entry of at least one of driver feedback and user commands; a sensor connectivity module configured to connect first user device to controller; and a network wirelessly connected to first user device, the network including: a storage device to store and a processor to analyze at least one of the requirements, driver feedback, user commands, and parameters.

### BACKGROUND OF THE DISCLOSURE

The embodiments disclosed herein generally relate to cold chain distribution systems, and more specifically to an apparatus and a method for cold-chain management.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated trucks and trailers are commonly used to transport perishable goods in a cold chain distribution system. A transport refrigeration system is mounted to the truck or to the trailer in operative association with a cargo space defined within the truck or trailer for maintaining a controlled temperature environment within the cargo space.

Conventionally, transport refrigeration systems used in connection with refrigerated trucks and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

Consumers are becoming increasingly concerned with the quality of the perishable goods they are purchasing and many factors must be controlled when attempting to maintain a high quality perishable good. It is often difficult manage the cold chain as the perishable goods may change hands several times along the route and are loaded in a variety of different trailers utilizing different refrigeration units. Improved systems, particularly improved systems for cold chain management would provide benefits to the industry.

### BRIEF DESCRIPTION OF THE DISCLOSURE

According to one embodiment, a system for managing perishable goods within a cold chain distribution system is provided. The system includes: a transport refrigeration system including: a refrigerated container; a refrigeration unit coupled to the refrigerated container, the refrigeration unit being configured to provide conditioned air to the refrigerated container; a controller configured to control the operation of the refrigeration unit; and a plurality of sensors configured to monitor parameters associated with at least one of the perishable goods, the refrigeration unit, and the refrigerated container, the plurality of sensors configured to transmit the parameters to the controller. The system also includes a first user device located proximate to the refrigerated container and configured to allow manual entry of at least one of driver feedback and user commands; a sensor connectivity module configured to connect the first user device to the controller; and a network wirelessly connected to the first user device, the network including: a storage device to store at least one of requirements, the driver feedback, the user commands, and the parameters; and a processor configured to analyze at least one of the requirements, the driver feedback, the user commands, and the parameters.

In addition to one or more of the features described above, or as an alternative, further embodiments of the system may include that the sensor connectivity module is configured to receive the parameters from the controller and transmit the parameters to the first user device.

In addition to one or more of the features described above, or as an alternative, further embodiments of the system may include that the processor is configured to transmit the parameters to a second user device.

In addition to one or more of the features described above, or as an alternative, further embodiments of the system may include that the processor is configured to receive user commands from the second user device.

In addition to one or more of the features described above, or as an alternative, further embodiments of the system may include that the processor is configured to transmit user commands to at least one of the first user device and the controller.

In addition to one or more of the features described above, or as an alternative, further embodiments of the system may include that the processor is configured to compare the requirements to at least one of the parameters, the driver feedback, and the user commands.

In addition to one or more of the features described above, or as an alternative, further embodiments of the system may include that the processor is configured to activate an alarm on the first user device when the requirements conflict with at least one of the parameters, the driver feedback, and the user commands.

In addition to one or more of the features described above, or as an alternative, further embodiments of the system may include that the processor is configured to compare the requirements to at least one of the parameters, the driver feedback, and the user commands.

In addition to one or more of the features described above, or as an alternative, further embodiments of the system may include that the processor is configured to activate an alarm on the second user device when the requirements conflict with at least one of the parameters, the driver feedback, and the user commands.

In addition to one or more of the features described above, or as an alternative, further embodiments of the system may include that the first user device is at least one of a mobile phone and tablet.

In addition to one or more of the features described above, or as an alternative, further embodiments of the system may include that the controller adjusts the operation of the refrigeration unit in response to the user commands.

According to another embodiment, a method of managing perishable goods within a cold chain distribution system is provided. The method including: transporting perishable goods, using a refrigerated container; cooling the perishable goods using a refrigeration unit coupled to the refrigerated container, the refrigeration unit being configured to provide conditioned air to the refrigerated container; controlling the operation of the refrigeration unit using a controller; monitoring, using a plurality of sensors, parameters associated with at least one of the perishable goods, the refrigeration unit, and the refrigerated container, the plurality of sensors configured to transmit the parameters to the controller; transmitting, using a network, at least one of driver feedback, user commands, and the parameters from a first user device to a storage device, the first user device being located proximate to the refrigerated container and configured to allow manual entry of at least one of driver feedback and user commands; storing, using the storage device, at least one of the driver feedback, the user commands, the parameters, and requirements; and analyzing, using a processor, at least one of the driver feedback, the user commands, the parameters, and the requirements.

In addition to one or more of the features described above, or as an alternative, further embodiments of the method may include transmitting, using a sensor connectivity module, the parameters from the controller to the first user device.

In addition to one or more of the features described above, or as an alternative, further embodiments of the method may include transmitting, using the processor, the parameters to a second user device.

In addition to one or more of the features described above, or as an alternative, further embodiments of the method may include receiving, using the processor, user commands from the second user device.

In addition to one or more of the features described above, or as an alternative, further embodiments of the method may include transmitting, using the processor, user commands to at least one of the first user device and the controller.

In addition to one or more of the features described above, or as an alternative, further embodiments of the method may include comparing, using the processor, the requirements to at least one of the parameters, the driver feedback, and the user commands.

In addition to one or more of the features described above, or as an alternative, further embodiments of the method may include activating, using the processor, an alarm on the first user device when the requirements conflict with at least one of the parameters, the driver feedback, and the user commands.

In addition to one or more of the features described above, or as an alternative, further embodiments of the method may include comparing, using the processor, the requirements to at least one of the parameters, the driver feedback, and the user commands.

In addition to one or more of the features described above, or as an alternative, further embodiments of the method may include activating, using the processor, an alarm on the second user device when the requirements conflict with at least one of the parameters, the driver feedback, and the user commands.

In addition to one or more of the features described above, or as an alternative, further embodiments of the method may include that the first user device is at least one of a mobile phone and tablet.

In addition to one or more of the features described above, or as an alternative, further embodiments of the method may include adjusting, using the controller, the operation of the refrigeration unit in response to the user commands.

Technical effects of embodiments of the present disclosure include tracking various parameters of perishable goods via a sensor connectivity module and transmitting the parameters to a network for further analysis and distribution.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a system for management of perishable goods within a cold chain distribution system, according to an embodiment of the present disclosure;

FIG. 2 illustrates a schematic view of a cold chain distribution system that may incorporate embodiments of the present disclosure; and

FIG. 3 is a flow diagram illustrating a method of managing perishable goods within a cold chain distribution system, according to an embodiment of the present disclosure.

### DETAILED DESCRIPTION OF THE DISCLOSURE

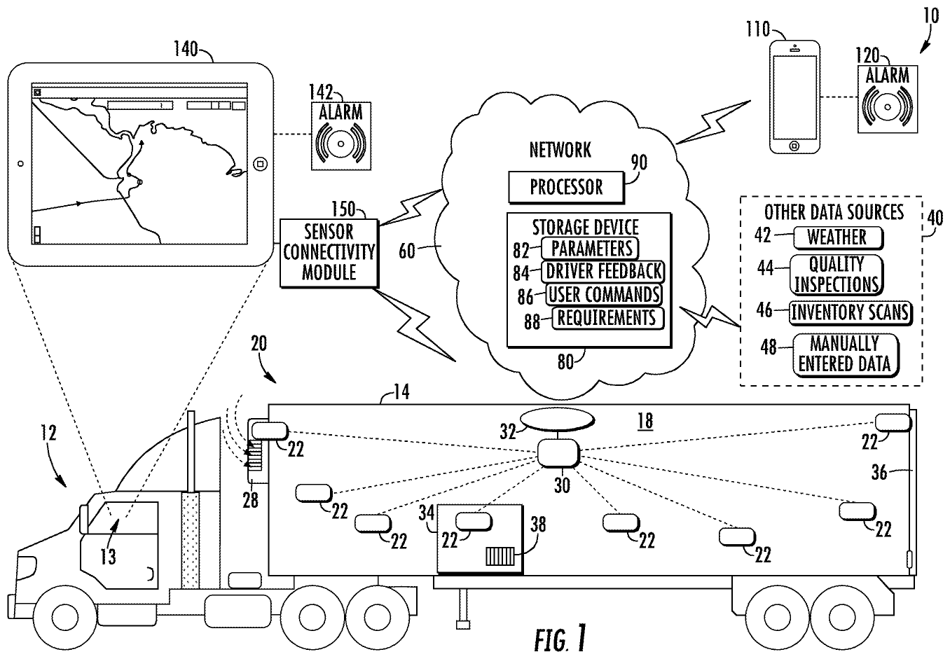

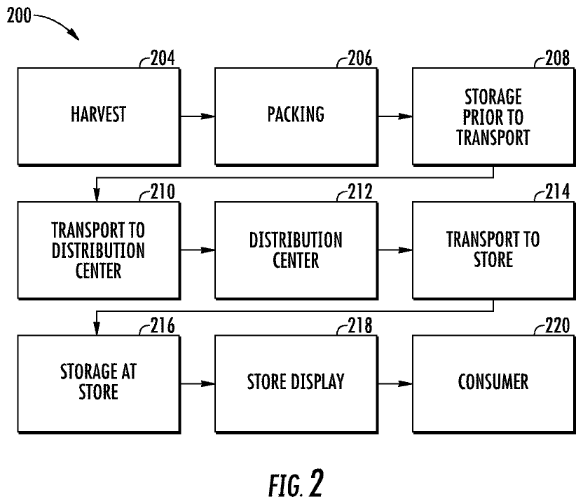

Referring now to the drawings, FIG. 1 illustrates a schematic view of a system 10 for managing perishable goods 34 within a cold chain distribution system 200, according to an embodiment of the present disclosure. FIG. 2 illustrates a schematic view of a cold chain distribution system 200 that may incorporate embodiments of the present disclosure. Typically, transport refrigeration systems 20 are used to transport and distribute perishable goods and environmentally sensitive goods (herein referred to as perishable goods 34). In the illustrated embodiment, a transport refrigeration system 20 includes the environmentally controlled refrigerated container 14, a transport refrigeration unit 28 and perishable goods 34. The refrigerated container 14 may be pulled by a tractor 12. The tractor 12 may have a cockpit 13 where a driver resides. It is understood that embodiments described herein may be applied to shipping containers that are shipped by rail, sea, or any other suitable container, without use of a tractor 12. The refrigerated container 14 may define an interior compartment 18.

In the illustrated embodiment, the transport refrigeration unit 28 is associated with a refrigerated container 14 to provide desired environmental parameters, such as, for example, temperature, pressure, humidity, carbon dioxide, ethylene, ozone, light exposure, vibration exposure, and other conditions to the interior compartment 18. In an embodiment, the transport refrigeration unit 28 is a refrigeration system capable of providing a desired temperature and humidity range. The perishable goods 34 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the transport refrigeration system 20 includes sensors 22, which may be hard wired or wireless. The sensors 22 may be utilized to monitor parameters 82 of the perishable goods 34. The parameters 82 monitored by the sensors 22 may include but are not limited to temperature, pressure, humidity, carbon dioxide, ethylene, ozone, light exposure, vibrations, and other conditions in the interior compartment 18. Accordingly, suitable sensors 22 are utilized to monitor the desired parameters 82. Advantageously, sensors 22 may be selected for certain applications depending on the type of perishable goods 34 to be monitored and the corresponding environmental sensitivities. For instance, perishable goods 34 that are hyper sensitive to carbon dioxide may require additional sensors 22 specifically for carbon dioxide. In an embodiment, temperatures are monitored. As seen in FIG. 1, the sensors 22 may be placed directly on the perishable goods 34.

Additionally, the sensors 22 may be placed in a variety of locations including but not limited to on the transport refrigeration unit 28, on a door 36 of the refrigerated container 14 and throughout the interior compartment 18. The sensors 22 may be placed directly within the transport refrigeration unit 28 to monitor the performance of the transport refrigeration unit 28. As seen, the sensors 22 may also be placed on the door 36 of the refrigerated container 14 to monitor the position of the door 36. Whether the door 36 is open or closed affects both the temperature of the refrigerated container 14 and the perishable goods 34. For instance, in hot weather, an open door 36 will allow cooled air to escape from the refrigerated container 14, causing the temperature of the interior compartment 18 to rise, thus affecting the temperature of the perishable goods 34 and potentially leading to spoilage. Additionally, a global positioning system (GPS) location may also be detected by the sensors 22. The GPS location may help in providing time-based location information for the perishable goods 34 that will help in tracking the travel route and other parameters 82 along that route. For instance, the GPS location may also help in providing information from other data sources 40 regarding weather 42 experienced by the refrigerated container 14 along the travel route. The local weather 42 affects the temperature of the refrigerated container 14 and thus may affect the temperature of the perishable goods 34. The parameters 82 may further be augmented with time, location stamps or other relevant information.

As illustrated in FIG. 1, the transport refrigeration system 20 may further include, a controller 30 configured to log a plurality of readings from the sensors 22, known as the parameters 82, at a selected sampling rate. The controller 30 may be enclosed within the transport refrigeration unit 28 or separate from the transport refrigeration unit 28 as illustrated. The controller 30 may also include a controller processor (not shown) and an associated memory (not shown). The controller processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In an illustrated embodiment, the transport refrigeration system 20 may include a communication module 32 in operative communication with the controller 30 and in operative communication with a sensor connectivity module 150. Depending on the refrigeration unit 28 age and brand, the refrigeration unit 28 may already be equipped with a communication module 32, otherwise a removable communication module 32 may be connected to the refrigeration unit 28. A removable communication module may be inserted in the refrigeration unit via a data transfer connection, such as, for example, USB, Thunderbolt, or any other similar connection type known to one of skill in the art. The communication module 32 is configured to transmit the parameters 82 to the sensor connectivity module 150 via wired communication and/or wireless communication. The wireless communication may be, but is not limited to, radio, optical, microwave, cellular, satellite, or another wireless communication method. The sensor connectivity module 150 may be operably connected to a first user device 140. The first user device 140 may be a device such as, for example, a cellular phone, tablet, laptop, smartwatch, a desktop computer or any other similar data input device known to one of skill in the art. In an embodiment, the first user 140 device is at least one of a mobile phone and tablet. The first user device 140 may be located in the cockpit 13 of the tractor 12 so that it is accessible to the driver or a copilot. The first user device 140 may be utilized to examine the parameters 82 and the driver may be able to enter driver feedback 84. The sensor connectivity module 150 may then relay the parameters 82 to a network 60 along with the driver feedback 84. Driver feedback 84 may include analysis of the parameters 82 or adjustments to the parameters 82. The network 60 may be but is not limited to satellite networks, cellular networks, cloud computing network, wide area network, or another type of wireless network.

Parameters 82 may also be provided by other data sources 40, as illustrated in FIG. 1. These other data sources 40 may be collected at any point throughout the cold chain distribution system 200, which as illustrated in FIG. 2 may include harvest 204, packing 206, storage prior to transport 208, transport to distribution center 210, distribution center 212, transport to store 214, storage at store 216, store display 218 and consumer 220. The perishable goods 34 may be carried in the refrigerated container 14 during the transport to distribution center 210 and the transport to store 214. These stages are provided for illustrative purposes and a distribution chain may include fewer stages or additional stages, such as, for example, a cleaning stage, a processing stage, and additional transportation stages. The other data sources 40 may include, but are not limited to, weather 42, quality inspections 44, inventory scans 46, and manually entered data 48. The weather 42, as discussed above, has an effect on the operation of the transport refrigeration unit 28 by influencing the temperature of the refrigerated container 14 during transport (e.g., 210 and 214) but the weather 42 also has other influences on the transport refrigeration unit 28. For instance, the weather 42 prior to and at harvest 204 may have an impact on the quality of the perishable goods 34. Moreover, quality inspections 44, similar to the weather 42, may reveal data of the perishable goods 34 that affects quality and potential for spoilage during transport. For instance, a particular batch of strawberries was subjected to rainfall just prior to harvest 204, making them prone to spoilage while in the refrigerated container 14. Quality inspections 44 may be done by a machine or a human being. Quality inspections 44 performed by a machine may be accomplished using a variety of techniques including but not limited to optical, odor, soundwave, infrared, or physical probe.

Further, inventory scans 46 may also reveal parameters 82 about the perishable goods 34 and may help in tracking the perishable goods 34. For instance, the inventory scan 46 may reveal the time, day, truck the perishable goods arrived on, which may help identify the farm if previously unknown. Knowing the origin of the perishable goods 34 may help in tracking potential contamination issues that may arise at a particular farm or production plant. For instance, if one farm experiences a listeria outbreak in a spinach crop, it would be important to identify the refrigerated container 14 carrying that particular spinach and remove the spinach from the refrigerated container 14 as soon as possible. While the system 10 includes sensors 22 to aid in automation, often times the need for manual data entry is unavoidable. The manually entered data 48 may be input via a variety of devices including but not limited to a cellular phone, tablet, laptop, smartwatch, a desktop computer or any other similar data input device known to one of skill in the art.

Parameters 82 collected throughout each stage of the cold chain distribution system 200 may include environment conditions experienced by the perishable goods 34 such as, for example, temperature, pressure, humidity, carbon dioxide, ethylene, ozone, vibrations, light exposure, weather, time and location. For instance, strawberries may have experienced an excessive shock or were kept at 34° F. during transport. Parameters 82 may further include attributes of the perishable goods 34 such as, for example, temperature, weight, size, sugar content, maturity, grade, ripeness, labeling, packaging and the type of perishable good. For instance, strawberries may be packaged in 1 pound clamshells, be a certain weight or grade, be organic, and have certain packaging or labels on the clamshells.

Parameters 82 may include information regarding the type of perishable good 34, which may help alert the driver to what perishable goods 34 are within the refrigerated container 14. This may also help prevent contamination issues between incompatible perishable goods 34. The type of perishable good 34 within the refrigerated container 14 may be identified by a manifest or contents list for the refrigerated container 14 as manually entered data 48. The type of perishable good 34 within the refrigerated container 14 may also be identified by inventory scans 46, or scans of ID tags 38. The ID tag 38 may be a Universal Product Code (UPC) bar code, Quick Response (QR) code, Radio-frequency identification (RFID) or another identification methodology known to one of skill in the art. Parameters 82 may also include information regarding the operation of the environmental control unit 28, as discussed above. The parameters 82 may further be augmented with time, location stamps or other relevant information.

In the illustrated embodiment, the system 10 further includes a storage device 80 to store the parameters 82 associated with the perishable goods 34. The storage device 90 may be located within the network 60 and/or operably connected to the network 60. At least one of the parameters 82 may be received from the first user device 140. The storage device 80 is connected to the communication module 32 through the network 60. The storage device 80 may be but is not limited to a random access memory (RAM), read only memory (ROM), or other electronic, optical, magnetic or any other computer readable medium. As shown, the storage device 80 also may store the driver feedback 84, user commands 86, and requirements 88. User commands 86 may include commands from the first user device and/or a second user device 110 to adjust the operations of the refrigeration unit 28. Requirements 88 may be requirements for handling and/or packaging the perishable good 34 such as, for example, government regulations or industry standards.

The network 60 may also include a processor 90 coupled to the storage device 80. The processor 90 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The processor 90 may be configured to analyze at least one of the parameters 82, the driver feedback 84, the user commands 86, and the requirements 88. The analysis may include comparing the requirements 88 to at least one of the parameters 82, driver feedback 84, and the requirements 88.

As mentioned above, the system 10 may also include a second user device 110. The second user device 140 may be a device such as, for example, a cellular phone, tablet, laptop, smartwatch, a desktop computer or any other similar data input device known to one of skill in the art. The parameters 82 may be accessible via the second user device 110 and/or sent directly to the second user device 110. The processor 90 may be configured to transmit the parameters 82 to the second user device 110. An individual may transmit user commands 86 to the processor 90 through the second user device 110. The user commands 86 may then be sent to the first user device 140. The user commands 86 may be sent from the first user device 140 to the communication module 32 through the sensor connectivity module 150. The communication module 32 will then transmit the user commands 86 to the controller 30 to adjust the performance of the refrigeration unit 28. For example, a parameter 82 may indicate that a temperature reading within the refrigerated container 14 is too high for strawberries, so a user may adjust the temperature of the refrigerated container 14 via their user device. The driver and/or copilot may also submit user commands 86 to the controller 30 through the first user device 140 to adjust the performance of the refrigeration unit 28. The communication modules 32 is configured to receive the user commands 86 from the second user device 110 and/or the first user device 140. Also, the communication module 32 is configured to transmit the user commands 86 to the controller 30. The controller 30 may adjust the operation of the refrigeration unit 28 in response to user commands 86.

The processor 90 may be configured to activate an alarm 142 on the first user device 140 when a requirement 88 conflicts with at least one of the parameters 82, driver feedback 84, and the requirements 88. The processor 90 may also be configured to activate an alarm 120 on the second user device 140 when a requirement 88 conflicts with at least one of the parameters 82, driver feedback 84, and the requirements 88. For instance, if the a user inputs a user command 86 on the first user device 140 to increase the temperature on the refrigeration unit 28 but that temperature conflicts with a requirement 88, the processor will active an alarm 140 on the first user device 140. The alarm 120 may be audible and/or visual.

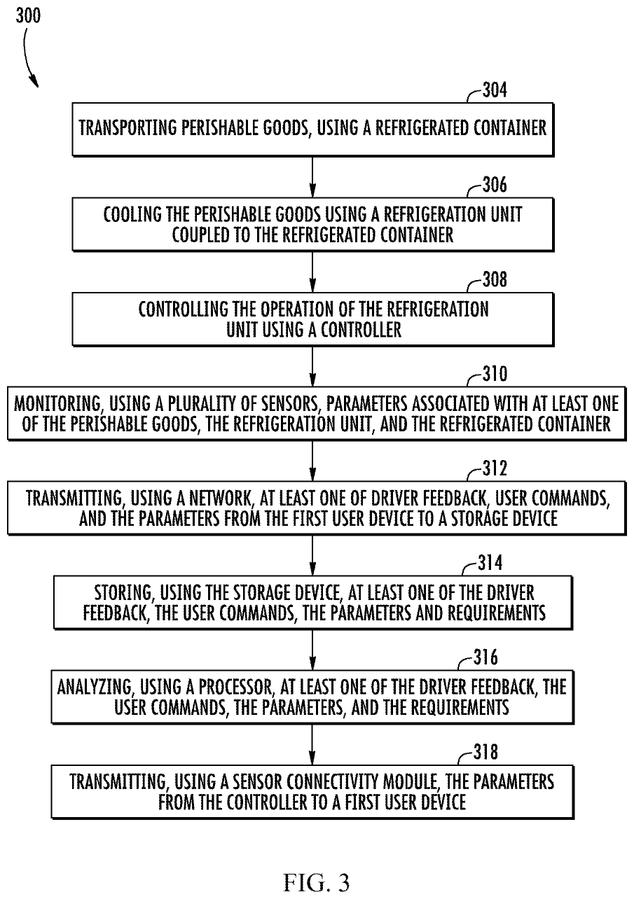

Referring now also to FIG. 3, which shows a flow diagram illustrating a method 300 of managing perishable goods 34 within a cold chain distribution system 200, according to an embodiment of the present disclosure. At block 304, the refrigerated container 14 transports the perishable goods 34. At block 306, the refrigeration unit 28 coupled to the refrigerated container 14 cools the perishable goods 34. The refrigeration unit 28 being configured to provide conditioned air to the refrigerated container 14. At block 308, the controller 30 controls the operation of the refrigeration unit 28. At block 310, the plurality of sensors 22 monitor parameters 82 associated with at least one of the perishable goods 34, the refrigeration unit 28, and the refrigerated container 14. For example, a parameter of the refrigerated container 14 may be whether or not the door 36 is open or closed. The plurality of sensors 22 are configured to transmit the parameters 82 to the controller 30.

At block 312, the network 60 transmits at least one of the driver feedback 84, the user commands 86, and the parameters 82 from the first user device 140 to the storage device 80. The first user device 140 being located proximate to the refrigerated container 14, for example, such as, in the cockpit 13. The first user device 140 being configured to allow manual entry of at least one of driver feedback 84 and user commands 86. At block 314, the user device 80 stores, at least one of the driver feedback 84, the user commands 86, the parameters 82, and the requirements 88. At block 316, the processor 90 analyzes at least one of the driver feedback 84, the user commands 86, the parameters 82, and the requirements 88. At block 318, the sensor connectivity module 150 transmits the parameters 82 from the controller 30 to a first user device 140.

The method 300 may include the processor 90 transmits the parameters 82 to a second user device 110. The method 300 may also include that the processor 90 receives user commands 86 from the second user device 110. The method 300 may further include that the processor 90 transmits user commands 86 to at least one of the first user device 140 and the controller 30. The method 300 may yet further include that the processor 90 compares the requirements 88 to at least one of the parameters 82, the driver feedback 84, and the user commands 86. The method 300 may yet still further include that the processor 90 activates the alarm 142 on the first user device 140 when the requirements 88 conflict with at least one of the parameters 82, the driver feedback 84, and the user commands 86. The method 300 may yet still further include that the processor 90 activates the alarm 120 on the second user device 110 when the requirements 88 conflict with at least one of the parameters 82, the driver feedback 84, and the user commands 86. The method 300 may also include the controller 30 adjusting the operation of the refrigeration unit 28 in response to the user commands 86.

While the above description has described the flow process of FIG. 3 in a particular order, it should be appreciated that unless otherwise specifically required in the attached claims that the ordering of the steps may be varied.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A system for managing perishable goods within a cold chain distribution system, the system comprising:
a transport refrigeration system including:
a refrigerated container;
a refrigeration unit coupled to the refrigerated container, the refrigeration unit being configured to provide conditioned air to the refrigerated container;
a controller configured to control the operation of the refrigeration unit; and
a plurality of sensors configured to monitor parameters associated with at least one of the perishable goods, the refrigeration unit, and the refrigerated container, the plurality of sensors configured to transmit the parameters to the controller;
a first user device located proximate to the refrigerated container and configured to allow manual entry of at least one of driver feedback and user commands;
a sensor connectivity module configured to connect the first user device to the controller; and
a network wirelessly connected to the first user device, the network including:
a storage device to store at least one of requirements, the driver feedback, the user commands, and the parameters; and
a processor configured to analyze at least one of the requirements, the driver feedback, the user commands, and the parameters.

2. The system of claim 1, wherein:
the sensor connectivity module is configured to receive the parameters from the controller and transmit the parameters to the first user device.

3. The system of claim 1, wherein:
the processor is configured to transmit the parameters to a second user device.

4. The system of claim 3, wherein:
the processor is configured to receive user commands from the second user device.

5. The system of claim 1, wherein:
the processor is configured to transmit user commands to at least one of the first user device and the controller.

6. The system of claim 1, wherein:
the processor is configured to compare the requirements to at least one of the parameters, the driver feedback, and the user commands.

7. The system of claim 6, wherein:
the processor is configured to activate an alarm on the first user device when the requirements conflict with at least one of the parameters, the driver feedback, and the user commands.

8. The system of claim 4, wherein:
the processor is configured to compare the requirements to at least one of the parameters, the driver feedback, and the user commands.

9. The system of claim 8, wherein:
the processor is configured to activate an alarm on the second user device when the requirements conflict with at least one of the parameters, the driver feedback, and the user commands.

10. The system of claim 1, wherein:
the first user device is at least one of a mobile phone and tablet.

11. The system of claim 1, wherein:
the controller adjusts the operation of the refrigeration unit in response to the user commands.

12. A method of managing perishable goods within a cold chain distribution system, the method comprising:
transporting perishable goods, using a refrigerated container;
cooling the perishable goods using a refrigeration unit coupled to the refrigerated container, the refrigeration unit being configured to provide conditioned air to the refrigerated container;
controlling the operation of the refrigeration unit using a controller;
monitoring, using a plurality of sensors, parameters associated with at least one of the perishable goods, the refrigeration unit, and the refrigerated container, the plurality of sensors configured to transmit the parameters to the controller;
transmitting, using a network, at least one of driver feedback, user commands, and the parameters from a first user device to a storage device, the first user device being located proximate to the refrigerated container and configured to allow manual entry of at least one of driver feedback and user commands;
storing, using the storage device, at least one of the driver feedback, the user commands, the parameters, and requirements; and
analyzing, using a processor, at least one of the driver feedback, the user commands, the parameters, and the requirements.

13. The method of claim 12, further comprising:
transmitting, using a sensor connectivity module, the parameters from the controller to the first user device.

14. The method of claim 12, further comprising:
transmitting, using the processor, the parameters to a second user device.

15. The method of claim 13, further comprising:
receiving, using the processor, user commands from the second user device.

16. The method of claim 12, further comprising:
transmitting, using the processor, user commands to at least one of the first user device and the controller.

17. The method of claim 12, further comprising:
comparing, using the processor, the requirements to at least one of the parameters, the driver feedback, and the user commands.

18. The method of claim 17, further comprising:
activating, using the processor, an alarm on the first user device when the requirements conflict with at least one of the parameters, the driver feedback, and the user commands.

19. The method of claim 15, further comprising:
comparing, using the processor, the requirements to at least one of the parameters, the driver feedback, and the user commands.

20. The method of claim 19, further comprising:
activating, using the processor, an alarm on the second user device when the requirements conflict with at least one of the parameters, the driver feedback, and the user commands.

21. (canceled)

22. (canceled)
